(19) United States
(12) Patent Application Publication
(10) Pub. No.: US 2010/0132654 A1
(43) Pub. Date: Jun. 3, 2010

(54) BALANCE SHAFT MODULE FOR VEHICLE

(75) Inventors: Byungsik Lee, Daegu (KR); Sangkyu Chai, Ansan-si (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION, Seoul (KR); METALDYNE KOREA LTD., Pyeongtaek (KR)

(21) Appl. No.: 12/630,824

(22) Filed: Dec. 3, 2009

(30) Foreign Application Priority Data
Dec. 3, 2008 (KR) 10-2008-0121959

(51) Int. Cl. F02B 75/06

(52) U.S. Cl. 123/192.2

(57) ABSTRACT

The present invention is directed to a balance shaft module for a vehicle. In the balance shaft module of the present invention, an intermediate gear is covered by a baffle cover, thus making it possible to prevent air from mixing into the engine oil when an intermediate gear rotates. Further, since an intermediate gear is supported with increased support force by a gear shaft, to the present invention provides a reduction in noise and frictional wear and improves durability while considerably improving the NVH (Noise Vibration Harshness) performance of a vehicle.

### CROSS-REFERENCE TO RELATED APPLICATIONS

The present application claims priority to Korean Patent Application Number 10-2008-0121959 filed Dec. 3, 2008, the entire contents of which application is incorporated herein for all purposes by this reference.

### BACKGROUND OF THE INVENTION

### 1. Field of the Invention

The present invention relates, in general, to a balance shaft module for a vehicle that largely reduces noise and friction wear and suitably improves durability and NVH (Noise Vibration Harshness) performance by increasing support force of an intermediate gear, and prevents air from mixing in the engine oil.

2. Description of Background Art

In general, a valance shaft module for maintaining quiet operation of an engine by reducing vibrations and noises generated while the engine operates, for example as shown in FIGS. 1 to 3, preferably includes: a balance shaft housing 2 that is suitably attached to the bottom of a cylinder block and equipped with an oil fan 1 at the lower side; an intermediate gear 6 that is rotatably attached to the front of balance shaft housing 2 by a gear bolt 3 and a bearing 4 and engaged with a crankshaft gear 5; a balance shaft 7 that is rotatably disposed longitudinally through balance shaft housing 2; and an input drive gear 9 that is suitably fitted on the front end of balance shaft 7 by a gear bolt 8 and suitably engaged with intermediate gear 6.

Reference numeral ‘10’ in FIG. 1 designates a crankshaft.

In the balance shaft module having the above described configuration, a large portion of it sinks in the oil in oil fan 1, such that air is mixed in the engine oil, and promotes frictional wear of engine parts, makes a noise, and deteriorates durability when gears 6, 9 rotate.

Further, in the balance shaft module of the related art, a gear bolt 3 passes through bearing 4 press-fitted in the center of intermediate gear 6 and gear bolt 3 passing through bearing 4 is screwed in balance shaft housing 2, such that intermediate gear 6 is suitably disposed in a cantilever-shaped support structure by gear bolt 3.

Accordingly, since an intermediate gear 6 is combined with a balance shaft housing 2 in the cantilever-shaped support structure, it is vulnerable to load and vibration when transmitting power. Accordingly, due to a change of backlash, issues such as gear noise and other noises, frictional wear, and deteriorating durability arose.

FIG. 4 illustrates an exemplary configuration when a baffle cover 11 is fastened to the front of balance shaft housing 2 by bolts 12.

Accordingly, a gear bolt 3 is screwed in a balance shaft housing 2 through the center of an intermediate gear 6 and a baffle cover 11 is suitably fastened to the front of balance shaft housing 2 by a plurality of bolts 12, suitably covering the front of intermediate gear 6.

Preferably, by fastening baffle cover 11 as described above, it is possible to maximally prevent air from mixing in the engine oil due to rotation of the gears and correspondingly overcome various problems; however, it is not changed that the intermediate gear 6 is suitably disposed in the cantilever-shaped support structure.

The information disclosed in this Background of the Invention section is only for enhancement of understanding of the general background of the invention and should not be taken as an acknowledgement or any form of suggestion that this information forms the prior art already known to a person skilled in the art.

### SUMMARY

to the present invention, in preferred aspects, provides a balance shaft module for a vehicle that can prevent, preferably maximally prevent, air from mixing into the engine oil due to rotation of gears, reduce a noise and frictional wear, and considerably improve durability and NVH (Noise Vibration Harshness) performance by suitably changing the structure such that an intermediate gear is supported with increased support force by both ends of a gear shaft.

In certain preferred embodiments of the present invention, a balance shaft module for a vehicle includes: a baffle cover that is suitably fastened to the front of a balance shaft housing with a gear space therebetween; an intermediate gear that is preferably inserted in the gear space and that is suitably engaged with a crankshaft gear and an input drive gear fitted on a balance shaft; and a gear shaft that is integrally fitted through the center of the intermediate gear and of which both ends suitably protruding from both sides of the intermediate gear are supported axial-rotatably with respect to the balance shaft housing and the baffle cover.

According further preferred embodiments of the present invention, in the balance shaft module, since an intermediate gear is suitably covered by a baffle cover, it is possible to prevent or maximally prevent air from mixing into the engine oil when the intermediate gear rotates. In further preferred embodiments, since the intermediate gear is suitably supported with increased support force by a gear shaft, it is possible to suitably reduce a noise and frictional wear and suitably improve durability while considerably improving the NVH (Noise Vibration Harshness) performance of a vehicle.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIGS. 1 and 2 are views illustrating a exemplary balance shaft module of the prior art.

FIG. 3 is a cross-sectional view taken along the line I-I of FIG. 2.

FIG. 4 is a cross-sectional view illustrating a balance shaft module of the prior art which is equipped with a baffle cover on the front of a balance shaft housing.

FIG. 5 is a view illustrating a balance shaft module with increased support force of an intermediate gear according to the present invention.

FIG. 6 is a cross-sectional view taken along the line II-II of FIG. 5

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

As described herein, the present invention includes a balance shaft module for a vehicle, comprising a baffle cover that is fastened to the front of a balance shaft housing, an intermediate gear, and a gear shaft.

In one embodiment, the baffle cover is fastened to the front of the balance shaft housing with a gear space there between.

In another embodiment, the intermediate gear is inserted in the gear space and engaged with a crankshaft gear and an input drive gear fitted on a balance shaft.

In another further embodiment, the gear shaft is integrally fitted through the center of the intermediate gear.

In still another embodiment, both ends of the gear shaft are protruding from both sides of the intermediate gear and are supported axial-rotatably with respect to the balance shaft housing and the baffle cover.

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

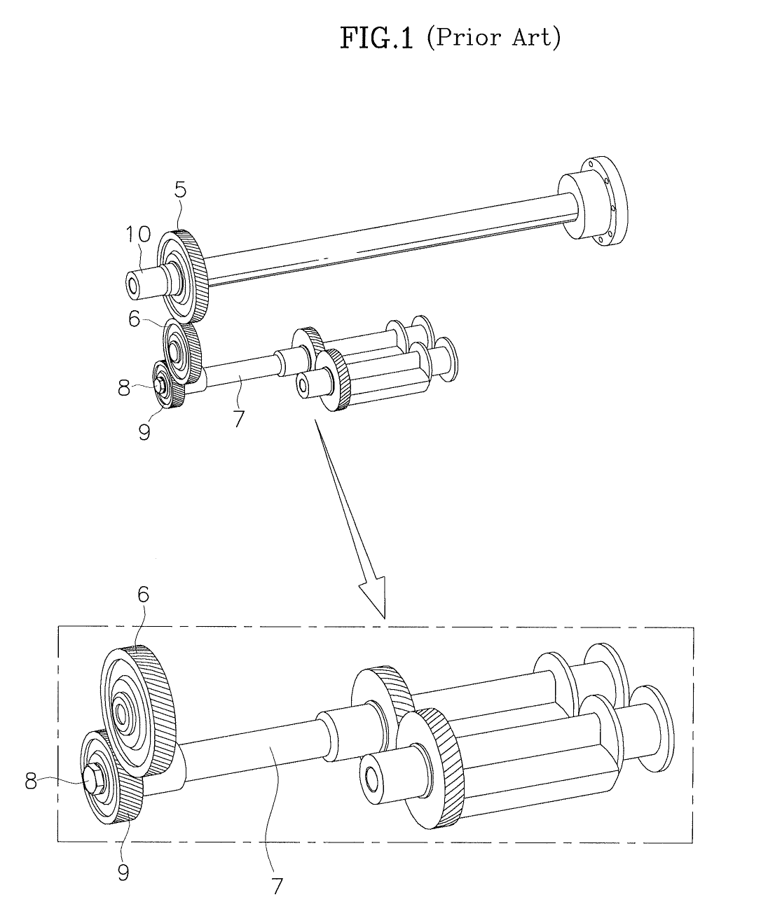

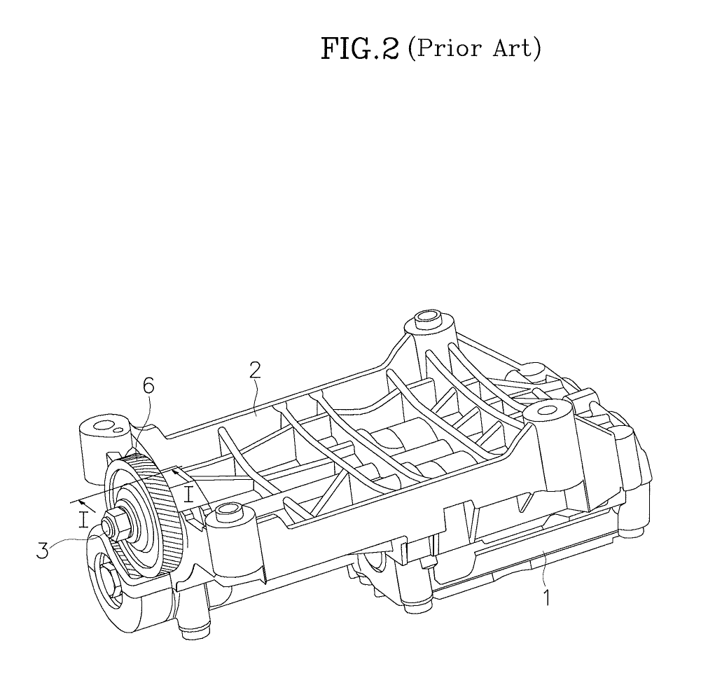

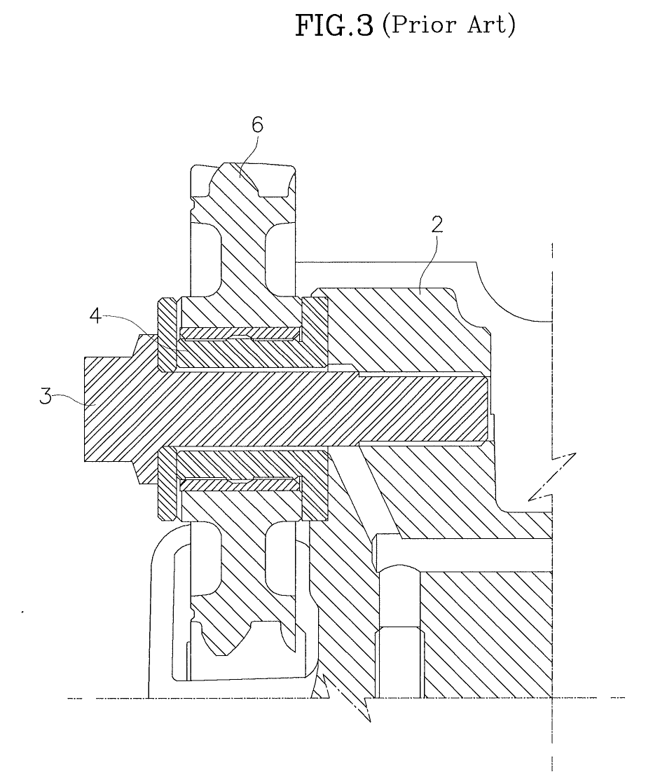

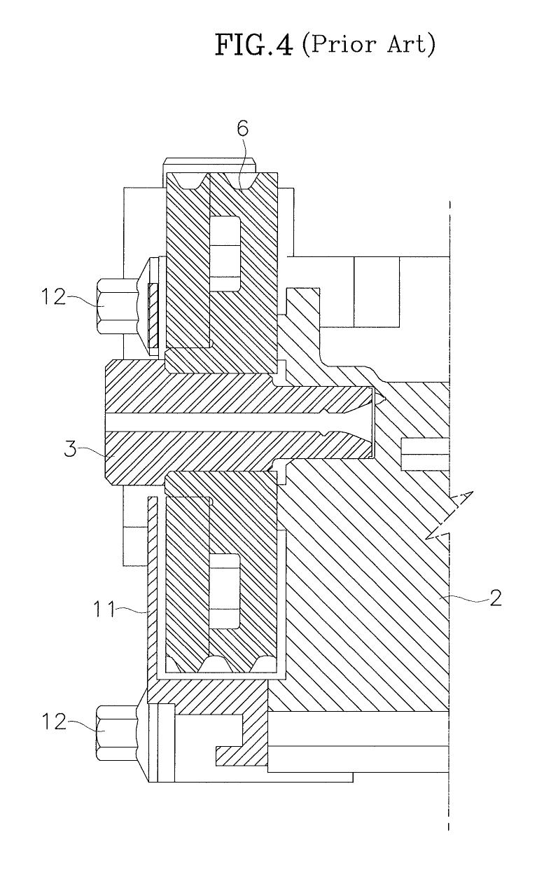

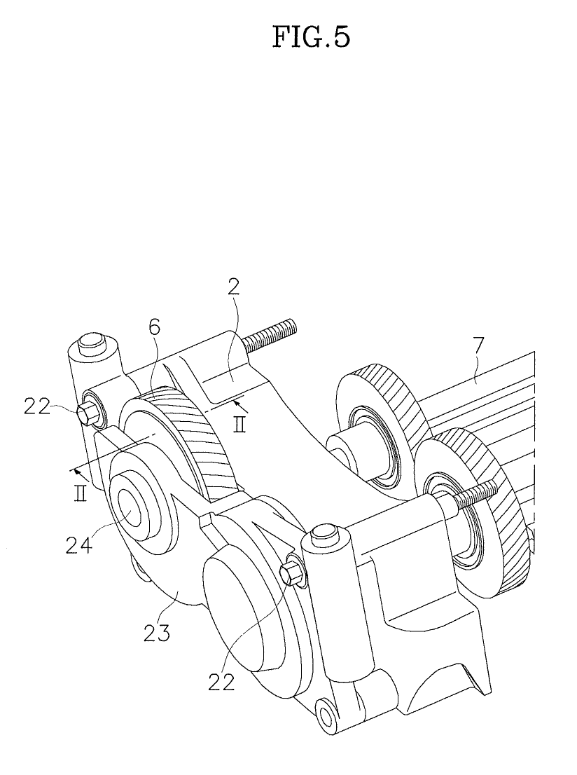

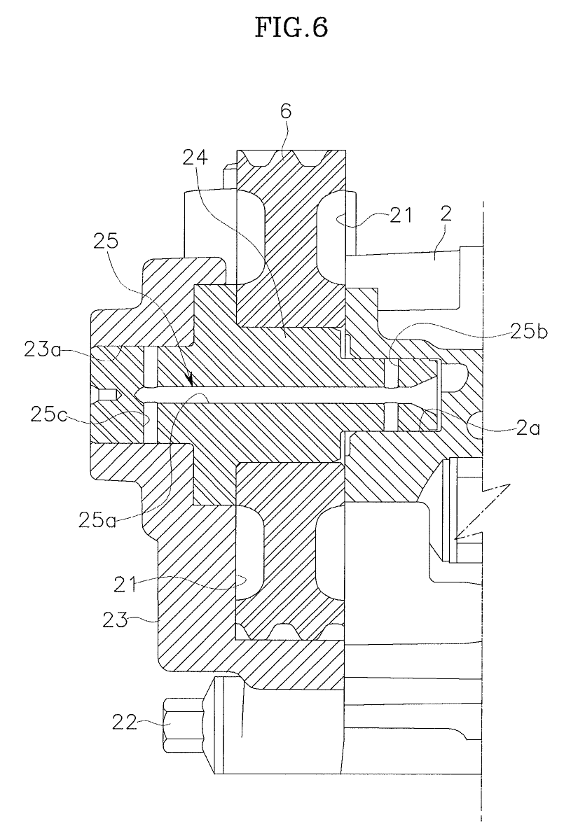

According to a preferred embodiment, a balance shaft module according to the present invention, for example as shown in FIGS. 5 and 6, preferably includes: a balance shaft housing 2 (see FIG. 2 for the shape) that is attached to the bottom of a cylinder block and suitably equipped with an oil fan 1 (see FIG. 1) at the lower side; a baffle cover 23 that is suitably fastened to the front of balance shaft housing 2 with a gear space 21 therebetween, by a plurality of bolts 22; an intermediate gear 6 that is suitably inserted in gear space 21 and suitably engaged with a crankshaft gear 5 (see FIG. 1) fitted on a crankshaft 10 (see FIG. 1); a gear shaft 24 that is integrally fitted through the center of an intermediate gear 6 and of which both ends protruding from both sides of intermediate gear 6 are supported axial-rotatably with respect to balance shaft housing 2 and baffle cover 23; a balance shaft 7 (see FIG. 1 for the shape) that is rotatably disposed longitudinally through balance shaft housing 2; and an input drive gear 9 (see FIG. 1) that is fitted on the front end of balance shaft 7 by a gear bolt 8 (see FIG. 1) and suitably engaged with intermediate gear 6.

Preferably, in this configuration, the intermediate gear 6 is disposed to be covered by baffle cover 23, and in further preferred embodiments, except for the portion engaged with crankshaft gear 5, the other portion of intermediate gear 6 is completely covered by baffle cover 23.

According to further preferred embodiments, shaft holes 2a, 23a where both ends of gear shaft 24 are respectively inserted are formed in balance shaft housing 2 and baffle cover 23.

In further related embodiments, shaft holes 2a, 23a supports axial-rotatably both ends of gear shaft 24, such that both ends of gear shaft 24 are suitably supported in shaft holes 2a, 23a and accordingly, an intermediate gear 6 is suitably supported with increased support force by gear shaft 24.

preferably, an oil channel 25 through which oil flows for lubrication of shaft hole 2a of balance shaft housing 2 and shaft hole 23a of baffle cover 23 is suitably formed through a gear shaft 24.

According to further preferred embodiments, an oil passage 25 is preferably composed of a main channel 25a that is horizontally formed longitudinally through the gear shaft 24 and of which one end is open to the shaft hole 2a of a balance shaft housing 2, and a rearward support channel 25b and a forward support channel 25c that are perpendicularly communicated with a main channel 25a and open to shaft hole 2a of balance shaft housing 2 and shaft hole 23a of baffle cover 23, respectively.

Accordingly, since the intermediate gear 6 is suitably covered by baffle cover 23 in the balance shaft module for a vehicle, it is possible to maximally prevent air from mixing into the engine oil when an intermediate gear 6 rotates, and as a result, it is possible to suitably remove problems that promote frictional wear of parts of the engine, deteriorate the durability, and make noise.

In further preferred embodiments, according to the balance shaft module of the present invention, since the intermediate gear 6 is integrally fitted on a gear shaft 24 and both ends of the gear shaft 24 are suitably inserted and axial-rotatably supported in shaft hole 2a of balance shaft housing 2 and shaft hole 23a of baffle cover 23, respectively, the intermediate gear 6 is suitably supported with increased support force by gear shaft 24.

Accordingly, in previously described shaft modules, the intermediate gear 6 is supported by being fastened to the balance shaft housing 2 in a cantilever-shaped support structure by a gear bolt 3, such that it is vulnerable to load and vibration when transmitting power. Accordingly, events due to change of backlash, such as making a gear noise and other noises, promoting frictional wear, and deteriorating durability were reported.

However, according to preferred embodiments of the present invention as described herein, since both ends of gear shaft 24 integrally fitted through the center of the intermediate gear 6 are inserted and axial-rotatably supported in shaft hole 2a of a balance shaft housing 2 and shaft hole 23a of baffle cover 23, respectively, the intermediate gear 6 is suitably supported with increased support force in the balance shaft module of the present invention, for example as compared with the cantilever-shaped support structure of the related art.

Accordingly, the structure according to the present invention overcomes the vulnerability to load and vibration in transmitting power, in addition to noise, frictional wear, and durability. Preferably, the present invention as described herein also increases the NVH (Noise Vibration Harshness) performance of a vehicle.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A balance shaft module for a vehicle, comprising:
a baffle cover fastened to the front of a balance shaft housing with a gear space therebetween;
an intermediate gear that is inserted in the gear space and engaged with a crankshaft gear and an input drive gear fitted on a balance shaft; and
a gear shaft that is integrally fitted through the center of the intermediate gear and of which both ends protruding from both sides of the intermediate gear are supported axial-rotatably with respect to the balance shaft housing and the baffle cover.

2. The balance shaft module as defined in claim 1, wherein the intermediate gear is covered by the baffle cover.

3. The balance shaft module as defined in claim 2, wherein the other portion of the intermediate gear is completely covered by the baffle cover, except for the portion engaged with the crankshaft gear.

4. The balance shaft module as defined in claim 1, wherein shaft holes where both ends of the gear shaft are respectively inserted are formed in the balance shaft housing and the baffle cover.

5. The balance shaft module as defined in claim 4, wherein both ends of the gear shaft is inserted and axial-rotatably supported in the shaft hole of the balance shaft housing and the shaft hole of the baffle cover, respectively.

6. The balance shaft module as defined in claim 4, wherein an oil channel through which oil flows for lubrication of the shaft hole of the balance shaft housing and the shaft hole of the baffle cover is formed through the gear shaft.

7. The balance shaft module as defined in claim 6, wherein the oil channel has a main channel that is horizontally formed longitudinally through the gear shaft and of which one end is open to the shaft hole of the balance shaft housing, and
a rearward support channel and a forward support channel that are perpendicularly communicated with the main channel and open to the shaft hole of the balance shaft housing and the shaft hole of the baffle cover, respectively.

8. A balance shaft module for a vehicle, comprising:
a baffle cover that is fastened to the front of a balance shaft housing;
an intermediate gear that is rotatably inserted in a space between the balance shaft housing and the baffle cover;
a gear shaft that is integrally fitted through the center of the intermediate gear and of which both ends are supported axial-rotatably with respect to the balance shaft housing and the baffle cover.

9. The balance shaft module as defined in claim 8, wherein the intermediate gear is disposed to be engaged with a crankshaft and an input driver fitted on a balance shaft, and
except for the portion engaged with the crankshaft gear, the other portion of intermediate gear is completely covered by the baffle cover.

10. The balance shaft module as defined in claim 8, wherein shaft holes where both ends of the gear shaft are respectively rotatably inserted are formed in the balance shaft housing and the baffle cover.

11. The balance shaft module as defined in claim 10, wherein an oil channel is formed through the gear shaft, and
the oil passage has a main channel that is horizontally formed longitudinally through the gear shaft and of which one end is open to a shaft hole of the balance shaft housing, and
a rearward support channel and a forward support channel that are perpendicularly communicated with the main channel and open to the shaft hole of the balance shaft housing and the shaft hole of the baffle cover, respectively.

12. A balance shaft module for a vehicle, comprising:
a baffle cover that is fastened to the front of a balance shaft housing;
an intermediate gear; and
a gear shaft.

13. The balance shaft module of claim 12, wherein the baffle cover is fastened to the front of the balance shaft housing with a gear space there between.

14. The balance shaft module of claim 12, wherein the intermediate gear is inserted in the gear space and engaged with a crankshaft gear and an input drive gear fitted on a balance shaft.

15. The balance shaft module of claim 12, wherein the gear shaft is integrally fitted through the center of the intermediate gear.

16. The balance shaft module of claim 15, wherein both ends of the gear shaft are protruding from both sides of the intermediate gear and are supported axial-rotatably with respect to the balance shaft housing and the baffle cover.
